(19) United States
(12) Patent Application Publication
(10) Pub. No.: US 2025/0316748 A1
(43) Pub. Date: Oct. 9, 2025

(54) METHOD FOR PRODUCING AN ACCUMULATOR AND DEVICE FOR PRODUCING AN ACCUMULATOR

(71) Applicants: Giesecke + Devrient Currency Technology GmbH, Muenchen (DE); Volkswagen Aktiengesellschaft, Wolfsburg (DE)

(72) Inventor: Markus SPERL, Muenchen (DE)

(73) Assignees: Giesecke + Devrient Currency Technology GmbH, Muenchen (DE); Volkswagen Aktiengesellschaft, Wolfsburg (DE)

(21) Appl. No.: 19/245,895

(22) Filed: Jun. 23, 2025

Related U.S. Application Data
(63) Continuation of application No. PCT/EP2023/086931, filed on Dec. 20, 2023.

(30) Foreign Application Priority Data
Dec. 21, 2022 (DE) 10 2022 214 102.4

(51) Int. Cl. H01M 10/04; H01M 10/0525; H01M 10/0585

(52) U.S. Cl. CPC H01M 10/049; H01M 10/0525; H01M 10/0585

(57) ABSTRACT

A method for producing an accumulator, having at least one cell stack, which is formed by stacked single sheets. The cell stack is wrapped with a film using a device.

This nonprovisional application is a continuation of International Application No. PCT/EP2023/086931, which was filed on Dec. 20, 2023, and which claims priority to German Patent Application No. 10 2022 214 102.4, which was filed in Germany on Dec. 21, 2022, and which are both herein incorporated by reference.

### BACKGROUND OF THE INVENTION

### Field of the Invention

The invention relates to a method for producing an accumulator. In addition, the invention relates to a device for producing an accumulator.

### Description of the Background Art

Accumulators are storage devices for electrical energy and are widespread. They are constructed of multiple accumulator cells in some application cases, and are used in fields including the automotive field. Here, the accumulators then serve as so-called propulsion or traction batteries for driving hybrid or electric vehicles, for example.

Lithium-ion accumulators, which is to say accumulators composed of lithium-ion cells, are currently of particular interest in this connection. A multiplicity of examples are known here with regard to the precise construction. The production of lithium-ion cells in this connection is outlined in Heimes, Heiner Hans; Kampker, Achim; Lienemann, Christoph; Locke, Marc; Offermanns, Christian; Michaelis, Sarah; Rahimzei, Ehsan, “Produktionsprozess einer Lithium-Ionen-Batteriezelle” [Production process for a lithium-ion battery cell], Frankfurt am Main, PEM der RWTH Aachen und VDMA Eigendruck (2018), for example.

### SUMMARY OF THE INVENTION

It is therefore an object of the invention to provide an advantageous method for producing an accumulator. In addition, the object of the invention is to specify an advantageous device for producing an accumulator.

This object is attained by a method and by a device. The advantages and examples cited with respect to the method can also be applied correspondingly to the device and vice versa.

The method according to the invention can be designed for the manufacture of an accumulator. The corresponding accumulator here typically has a number of accumulator cells, wherein such an accumulator cell customarily has a cell housing or a cell enclosure. Depending on the application case, the accumulator is therefore made of a single accumulator cell, for example. Customarily, however, the accumulator has multiple such accumulator cells, and generally forms a battery or a battery module. A corresponding battery, in turn, typically has a battery housing, and a corresponding battery module customarily has a module housing or a carrier unit for accumulator cells. If the accumulator is designed as a battery, then in some cases it has a number of the aforementioned battery modules, which is to say at least one such battery module and typically several.

The accumulator produced via the method can have at least one cell stack that is made of stacked single sheets. If the accumulator is constructed of aforementioned accumulator cells, each accumulator cell typically has such a cell stack, namely exactly one, in particular. Moreover, each one of these accumulator cells is can be designed as a so-called pouch cell.

Furthermore, the cell stack expediently forms a so-called electrode stack. This means that a layering or stacking that has electrode materials is present in the cell stack. In addition, the accumulator can be designed as a lithium-ion accumulator. Therefore, the layering or stacking in the cell stack typically has an anode material, a separator material, and a cathode material.

Suitable single sheets for manufacturing a corresponding cell stack for the aforementioned lithium-ion accumulator and a possible method for producing such single sheets are described in Heimes, Heiner Hans; Kampker, Achim; Lienemann, Christoph; Locke, Marc; Offermanns, Christian; Michaelis, Sarah; Rahimzei, Ehsan, “Produktionsprozess einer Lithium-Ionen-Batteriezelle” [Production process for a lithium-ion battery cell], Frankfurt am Main, PEM der RWTH Aachen und VDMA Eigendruck (2018), for example. The corresponding single sheets are referred to there as “sheets.”

In this connection, three different sheets, which is to say single sheets, are manufactured in this specific example, namely anode single sheets a, which have an anode material, separator single sheets b, which have a separator material, and cathode single sheets c, which have a cathode material. To produce a corresponding cell stack, such single sheets are then expediently stacked in a sequence abcabc and so forth.

In accordance with an alternative variant, single sheets are used that are designed as so-called monocells. Such monocell single sheets typically have an anode material, a cathode material, and a separator material located therebetween.

Regardless thereof, the single sheets have a length, a width, and a height or thickness. For the height, a value is typical in this case that lies in the range of 0.05 mm to 2.5 mm and, in particular, in the range of 0.1 mm to 1.5 mm. For length and width, values are customary in each case that are greater by at least a factor of 5 or by at least a factor of 10.

A cell stack that is made of stacked single sheets of the above-described type is now wrapped with a film during the course of performing the method, which is to say the method according to the invention. The method for producing the accumulator thus includes a method part of film application, in which the cell stack is wrapped with the film. This method part of film application is performed in this case via the device according to the invention, namely in completely automated fashion, in particular.

The device, in turn, which is to say the device according to the invention, is designed to produce the above-described accumulator via the method according to the invention and, in particular, to automatically perform the method part of film application in at least one operating mode. The automatic performance in this case is typically controlled by a control unit of the device.

Preferably, the performance of the method part of film application, and thus the wrapping of the cell stack with the film, takes place in an intermediate step. This intermediate step in this connection is performed after a method step in which the single sheets are stacked to form the cell stack, and before a method step in which the cell stack is placed in a cell housing or a cell enclosure.

In addition, the intermediate step typically is performed prior to a method step in which the cell stack is subjected to a heat treatment, in particular a so-called hot pressing. During the heat treatment, the cell stack is then typically laminated to form a solid block. In some application cases, the film is removed by pyrolysis during the heat treatment as well.

Regardless thereof, the film can form neither a cell enclosure nor a cell housing for the cell stack, and further can also form no part of such a cell enclosure or such a cell housing.

Furthermore, a simple film without coating can be used as film. In this case, the film can be composed of a thermoplastic film, which is to say, for example, of a film made of polyethylene. According to an alternative design version, a film made of a separator material, in particular a film made of the separator material that is contained in the cell stack, is used as film.

Depending on the application case, moreover, a film is used having a height or thickness whose value lies in the range of 0.05 mm to 0.2 mm. Also preferably, the cell stack can be wrapped a single time with the film so that only one layer of the film lies on the cell stack. A multilayer wrapping is thus dispensed with, in particular.

It is additionally expedient when the cell stack is fed to a film application unit of the device for the purpose of wrapping with the film. In this case, the cell stack further preferably can be moved toward a section of the film that is stretched in a gate plane. The gate plane is defined in this case by an entry gate of the film application unit.

The gate plane in this case can extend in the vertical direction with respect to the earth, or at least in a good approximation of the vertical direction. “In a good approximation” in this case may mean that the actual direction preferably does not deviate more than 30°, further preferably not more than 20°, and in particular not more than 10° from the vertical direction. In addition, the gate plane extends in a transverse direction transverse to the vertical direction. In this connection, then, the cell stack further preferably can be moved in a conveying direction toward the section of the film, wherein the conveying direction preferably can be perpendicular, or in a good approximation of perpendicular, to the vertical direction on the one hand and perpendicular, or in a good approximation of perpendicular, to the transverse direction on the other hand. “In a good approximation” in this case may mean again that the deviation preferably is not more than 30°, further preferably not more than 20°, and in particular not more than 10°.

Furthermore, the section of the film can be stretched via a number of rollers of the film application unit. In this case, at least two supply rollers, also called supply reels, are typically provided. Further preferably, at least one of these supply rollers is then designed as a driven roller. Depending on the application case, at least one guide roller is additionally provided. In particular, the number of rollers includes at least two rollers that are arranged offset from one another in the vertical direction and between which the section of the film is guided along the gate plane.

For the purpose of wrapping with the film, the cell stack can be moved in the aforementioned conveying direction, with a front side of the cell stack in front, toward the section of the film that is stretched in the gate plane.

Depending on the application case, the section is then moved in the vertical direction as soon as the front side of the cell stack reaches the gate plane and thus the section. The section is only moved a little in this process, which is to say typically over a distance that is less than the height of the cell stack, which is to say the dimension of the cell stack in the vertical direction. During this process, protruding edges made of separator material, which is to say separator ends, of the cell stack can be bent over in the vertical direction and, in particular, joined to one another in the process, by the moving of the section.

Typically, furthermore, a conveyor line of the film application unit adjoins the entry gate of the film application unit. The conveyor line here is designed to convey the cell stack in the aforementioned conveying direction, at least once the cell stack has been fed through the entry gate to the conveyor line. In this case, then, after the cell stack has been moved toward the section, the cell stack can be guided into the conveyor line, and here is further conveyed in the conveying direction. In this process, the film is then carried along by the cell stack so that the film is folded around the cell stack, namely in a U-shape, in particular.

Moreover, an example is expedient in which the conveyor line has two conveyor belts that are arranged one above the other, and between which the cell stacks are then conveyed through. In this process, the two conveyor belts further can exert pressure on the cell stack, which pressure acts on the cell stack in the vertical direction and opposite the vertical direction. The film is placed firmly against the surface of the cell stack by this means.

It is additionally advantageous when the film application unit and, in particular, the entry gate has a slide that can move in the vertical direction, namely along the gate plane, in particular. The slide can then be moved as soon as a rear side of the cell stack opposite the front side has passed through the gate plane, via which the film expediently is folded around the rear side of the cell stack by the slide.

In the case of a cell stack thus produced, the film forms a sleeve with two sleeve ends. The two sleeve ends then further can be joined to one another. The joining in this case can be accomplished by welding, in particular by welding via a heating element.

A corresponding heating element in this case typically is elongated in the aforementioned transverse direction and made of, e.g., a heating wire. Furthermore the heating element, namely the first heating element, is formed on the slide, for example. According to an example, the first heating element is formed on an outer support for the slide, against which the slide presses after the above-described movement.

Two heating elements can be provided, namely the first heating element and a second heating element, wherein typically each of the two heating elements can be elongated in the aforementioned transverse direction. In addition, they can be arranged offset from one another in the aforementioned conveying direction. Both heating elements are then formed on the slide or on the aforementioned outer support, for example. Alternatively, one heating element is formed on the slide and one heating element on the aforementioned outer support.

The two aforementioned sleeve ends can be welded to one another using the first heating element. In this way, then, the film usually is additionally detached from a film web that extends between the two aforementioned supply rollers. As a result, the film web is separated into two web sections. The two web sections can then be welded together again by the aforementioned second heating element to form one film web, via which the initial state in which a film section is stretched in the gate plane is achieved again, in particular. The detachment of the film from the film web and the welding together of the two web sections is accomplished more or less simultaneously by the two heating elements in this case.

The advantages and improvements described in connection with the method should also be applied correspondingly to the device and vice versa.

In summary, the idea underlying the method according to the invention and underlying the device according to the invention can also be expressed as follows: When a cell stack, or stack for short, is completely stacked, the stack is pushed against a film curtain. For example, one of the film supply reels that stretch the film curtain is driven at the same time so that the film is wound onto the driven film supply reel and unwound from the other, but only a short distance, so that the protruding edges of the separators in the cell stack are bent over, optionally either upward or downward, owing to the relative speed. As a result, the edges of the separators on the front side are joined to one another. When the stack has passed far enough through the film curtain that the end is flush with the curtain plane, then the pack transport comes to a stop. After that, a slide travels upward, carries the film along, in doing so bends over the edges of the separators on the other side of the pack, and travels toward a heating element that thermally welds the films together. The heating element can be designed such that it creates two weld seams that are closely adjacent to one another, the one on the stack side, the other on the film side. Between the two weld seams, the film is severed by strong compression so that a continuous film curtain with a weld seam is produced on the one hand, and a film-enclosed pack. The continuous film curtain including weld seam is now ready for the next pack.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a device having a gripper and a film application unit,

FIG. 2 shows enlarged, the gripper with a cell stack, and a pick-up of the film application unit,

FIG. 3 shows enlarged, the gripper and the pick-up during a transfer of the cell stack,

FIG. 4 shows enlarged, the pick-up and an entry gate of a conveyor line of the film application unit with the cell stack at the entry gate,

FIG. 5 shows enlarged, the entry gate of the conveyor line with the cell stack after passage through the entry gate,

FIG. 6 shows enlarged, the entry gate of the conveyor line with the cell stack after passage through the entry gate and the movement of a slide of the entry gate,

FIG. 7 shows enlarged, the entry gate of the conveyor line with the cell stack after resetting of the slide, and

FIG. 8 shows a single sheet of the cell stack.

### DETAILED DESCRIPTION

A device 2 described below by way of example serves to automatically perform a method part of film application, in which a cell stack 4, which is composed of stacked single sheets 6, is wrapped with a film 8. The method part of film application in this case is part of a method for producing accumulators (not shown), namely lithium-ion accumulators, wherein each accumulator has at least one such cell stack 4. The automatic performance in this case typically is controlled by a control unit, not depicted, of the device 2.

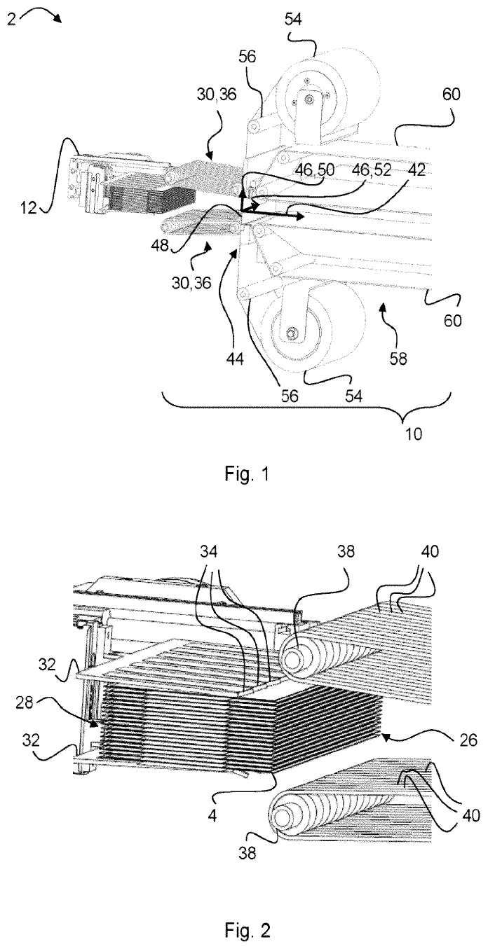

Now, the device 2 described here has a film application unit 10 as well as a gripper 12. A corresponding design version is shown in FIG. 1 in this case. FIG. 2 to FIG. 7 depict details from FIG. 1 in enlarged form, namely at different points in time during performance of the method part of film application.

In operation of the device 2, and thus during the course of performing the method part of film application, the cell stack 4 composed of stacked single sheets 6 is fed to the film application unit 10 by the gripper 12.

By way of example, all single sheets 6 are designed identically. Such a single sheet 6 is sketched as an example in FIG. 8. It is designed as a so-called monocell and has a layer made of an anode material 14, a layer made of a cathode material 16, and a layer located therebetween made of a separator material 18. The layer made of the separator material 18 here forms two protruding edges, which hereinafter are referred to as separator ends 20. In FIG. 8, one of these separator ends 20 protrudes on the left side, and one on the right side.

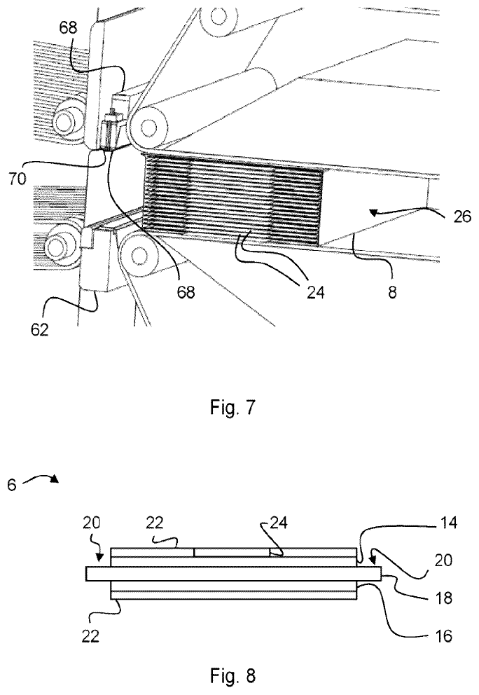

In addition, the single sheet 6 has two electrically conductive current collector films 22, wherein one of the current collector films 22 adjoins the anode material 14 and the other adjoins the cathode material 16. Each of the two current collector films 22 here forms a so-called current collector tab 24, wherein the two current collector tabs 24 protrude on opposite sides of the single sheet 6. In FIG. 7, only the current collector tab 24 of the current collector film 22 that projects out of the plane of the drawing is visible on the anode material 14.

Multiple such single sheets 6 are now stacked on top of one another in the cell stack 4, namely in such a manner that all single sheets 6 in the cell stack 4 are uniformly aligned and uniformly oriented. The separator ends 20 in this case protrude on a front side 26 of the cell stack 4 and on an opposite rear side 28.

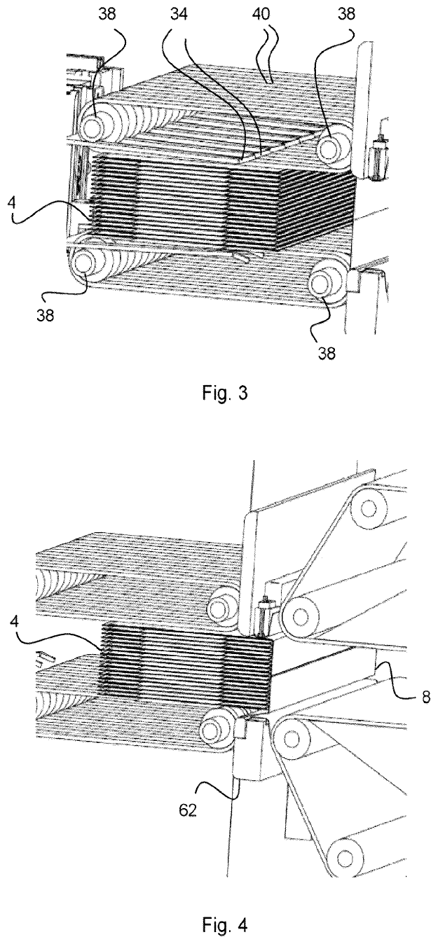

In order to wrap the cell stack 4 with the film 8, the cell stack 4 is now fed to the film application unit 10 in that the stack is transferred by the gripper 12 to a pick-up 30 of the film application unit 10. This is shown in FIG. 3.

Various examples are expedient for the gripper 12. In the case of the example from FIG. 1, the gripper 12 has two gripper jaws 32, which are movable toward one another and away from one another, via which a grabbing, as it were, is made possible. The two gripper jaws 32 furthermore are connected in a manner that is not shown in detail, for example by a telescoping arm to a shaft about which the telescoping arm is rotatable. The shaft, in turn, is mounted on a rail so as to be vertically movable, for example.

In the case of the example from FIG. 1, the two gripper jaws 32 furthermore are identically designed, and each have a shape that is reminiscent of a comb. In order to form such a comb shape here, multiple parallel slats 34 are arranged next to one another. This is clearly evident from FIG. 2.

The design of the two gripper jaws 32 is matched to the pick-up 30 in this case. The pick-up 30 in this case is formed by two gripper jaws 36. Each of these gripper jaws 32 here is designed in the manner of a single conveyor belt with two drive rollers 38, but instead of a single wide belt, multiple narrow bands 40 are stretched between the two drive rollers 38 and arranged next to one another in this design, as is shown in FIG. 2, for example.

In this case, a gap is left between each of the bands 40 so that the slats 34 of the gripper jaws 32 of the first gripper 12 can be positioned between the bands 40. This situation is indicated in FIG. 3. In addition, the two gripper jaws 36 of the pick-up 30 are each supported such that they can pivot about one of the drive rollers 38 so that they can be moved like the two jaws of pincers.

Once the cell stack 4 has been transferred, then the pick-up 30 conveys the cell stack 4, with its front side 26 in front, along a conveying direction 42 toward an entry gate 44 of the film application unit 10. The entry gate 44 in this case defines a gate plane 46 in which, in an initial state, a section 48 of the film 8 is stretched. This situation can be seen in FIG. 1 and FIG. 2.

In the example from FIG. 1, the gate plane 46 in this case extends in a vertical direction 50 with respect to the earth, perpendicular to the conveying direction 42. In addition, the gate plane 46 extends in a transverse direction 52 perpendicular to the vertical direction 50 and perpendicular to the conveying direction 42.

Furthermore, the section 48 of the film 8 can be stretched via two roller pairs of the film application unit 10. In this context, two supply rollers 54 form one of the roller pairs, and two guide rollers 56 form the other roller pair. The supply rollers 54 are driven in this case.

For the purpose of wrapping with the film 8, the cell stack 4 is now moved in the conveying direction 42, with the front side 26 of the cell stack 4 in front, toward the section 48 of the film 8 that is stretched in the gate plane 46. In this process, the section 48 is then moved in the vertical direction 50 via the driven supply rollers 54 as soon as the front side 26 of the cell stack 4 reaches the gate plane 46 and thus the section 48. The section 48 is only moved a little in this process, which is to say typically over a distance that is less than the height of the cell stack 4, which is to say the dimension of the cell stack 4 in the vertical direction 50. In this case, the separator ends 20 of the cell stack 4 protruding at the front side 26 are bent over in the vertical direction 50 and joined to one another in the process, by the moving of the section 48.

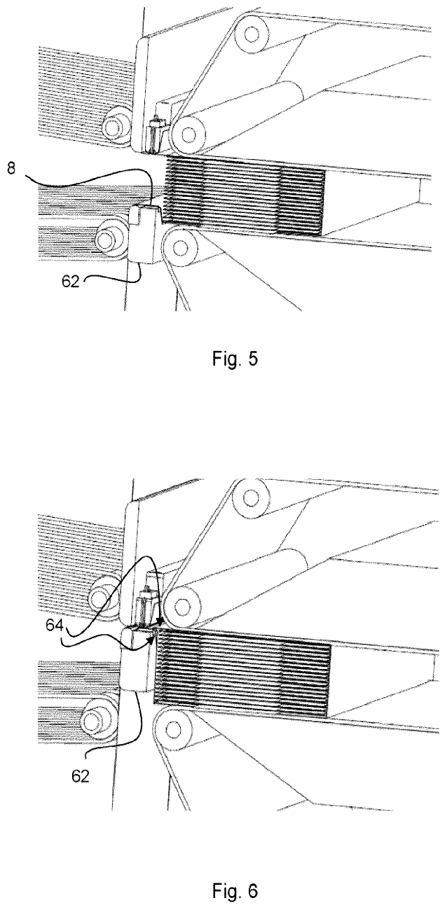

In addition, a conveyor line 58 of the film application unit 10 adjoins the entry gate 44 in the example. The conveyor line 58 in this case is designed to convey the cell stack 4 further along the conveying direction 42, at least once the cell stack 4 has been fed through the entry gate 44 to the conveyor line 58, as FIG. 4 shows. Subsequently, the cell stack 4 is conveyed further by the conveyor line 58, wherein the film 8 is carried along by the cell stack 4 so that the film is folded around the cell stack 4, namely in a U-shape. This situation can be seen in FIG. 5.

The conveyor line 58 in this case has two conveyor belts 60 that are arranged one above the other, and between which the cell stack 4 is then conveyed through. In this process, the two conveyor belts 60 exert pressure on the cell stack 4, which pressure acts on the cell stack 4 in the vertical direction 50 and opposite the vertical direction 50. The film 8 is placed firmly against the surface of the cell stack 4 by this means.

The entry gate 44 additionally has a slide 62 that can move in the vertical direction 50, namely along the gate plane 46. The slide 62 in this case is moved as soon as the rear side 28 of the cell stack 4 has passed through the gate plane 46, via which the film 8 is folded around the rear side 28 of the cell stack 4 by the slide 62. As a result, the film 8 then forms a sleeve with two sleeve ends 64. The two sleeve ends 64 then further can be joined to one another.

Since the film 8 in the example is composed of a thermoplastic film, the joining here is accomplished by welding via a heating element 66. The corresponding heating element 66 in this case is elongated in the transverse direction 52 and made of a heating wire, for example. Furthermore the heating element 66 according to FIG. 7 is formed on an outer support 68 for the slide 62, against which the slide 62 presses after the movement, as shown in FIG. 6.

In addition, another heating element 70 is formed, which likewise is elongated in the transverse direction 52. In this case, the two heating element 66, 70 are arranged offset from one another in the conveying direction 42. Both heating elements are formed on the outer support 68, moreover.

The two aforementioned sleeve ends 64 are now welded to one another using the first heating element 66. In this way, then, the film 8 usually is additionally detached from a film web that extends between the two aforementioned supply rollers 54. As a result, the film web is separated into two web sections. The two web sections further are then welded together again by the aforementioned second heating element 70 to form one film web, via which the initial state is achieved again, in particular.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for producing an accumulator, the method comprising:
providing at least one cell stack that is formed by stacked single sheets; and
wrapping the cell stack with a film via a device.

2. The method according to claim 1, wherein the cell stack is wrapped with the film in an intermediate step that is performed after a step in which the single sheets are stacked to form the cell stack, and before a step in which the cell stack is placed in a cell enclosure.

3. The method according to claim 1, wherein the cell stack is fed to a film application unit of the device for wrapping with the film, and wherein a section of the film is stretched in a gate plane of an entry gate.

4. The method according to claim 3, wherein the cell stack is moved in a conveying direction with a front side of the cell stack in front, toward the section.

5. The method according to claim 4, wherein the section is moved in a vertical direction as soon as the front side of the cell stack reaches the section so that projecting separator ends of the cell stack are bent over in the vertical direction.

6. The method according to claim 4, wherein the section is stretched at the beginning of a conveyor line, which extends in the conveying direction of the film application unit, wherein the conveyor line has two conveyor belts that are arranged one above the other, wherein the cell stack is guided into the conveyor line, and wherein the cell stack is conveyed in the conveying direction clamped between the two conveyor belts, via which the film is folded around the cell stack.

7. The method according to claim 6, wherein a slide of the entry gate is moved in a vertical direction as soon as a rear side of the cell stack opposite the front side passes through the gate plane so that the film is folded around the rear side of the cell stack.

8. The method according to claim 1, wherein, after the wrapping of the cell stack, the film forms a sleeve with two sleeve ends, and wherein the two sleeve ends are welded to one another via a heating element.

9. The method according to claim 1, wherein the film is detached from a film web so that the film web is separated into two web sections, and wherein the two web sections are welded together via a heating element.

10. A device for producing an accumulator via the method according to claim 1.
